(19) United States
(12) Patent Application Publication
(10) Pub. No.: US 2010/0036666 A1
(43) Pub. Date: Feb. 11, 2010

(54) METHOD AND SYSTEM FOR PROVIDING META DATA FOR A WORK

(75) Inventors: Nathan D. Ampunan, Novi, MI (US); Timothy J. Grost, Clarkston, MI (US); Kevin W. Owens, Sterling Heights, MI (US)

Correspondence Address: Julia Church Dierker;Dierker & Associates, P.C., 3331 W. Big Beaver Road, Suite 109, Troy, MI, 48084-2813, US

(73) Assignee: GM GLOBAL TECHNOLOGY OPERATIONS, INC., DETROIT, MI (US)

(21) Appl. No.: 12/189,111

(22) Filed: Aug. 8, 2008

(51) Int. Cl. G10L 15/04; G06F 7/06; G10L 13/08; G06F 17/30

(52) U.S. Cl. 704/251; 707/3; 704/260; 707/E17.014; 707/E17.015; 704/E15.001; 704/E13.001

(57) ABSTRACT

A method for providing meta data for a work includes designating a file for uploading data associated therewith to a telematics unit operatively connected to a vehicle; and using meta data associated with the designed file, obtaining phonetic meta data for the designed file from an on-line service. The method further includes creating a phonetic meta data file associated with the designed file and including the obtained phonetic meta data, and transferring the phonetic metal data file to the telematics unit. Also disclosed herein is a system for providing the same.

### TECHNICAL FIELD

The present disclosure relates generally to methods and systems for providing meta data for a work.

### BACKGROUND

Many currently manufactured mobile vehicles are outfitted with suitable digital music playing capabilities. For example, the vehicle may be configured to play music from a portable digital music device (such as, e.g., an iPod®, commercially available from Apple Computer, Inc.), from an embedded digital music device, or both. It may, in some instances, be beneficial to provide the user of the vehicle with information related to the title of a song, the artist performing the song, the album on which the song was recorded, a picture of the cover of the album, the year the song was recorded, and/or the like. Such information may be displayed to a user on a display, for example, of an in-vehicle radio. In some instances, the information may be audibly output to the in-vehicle user(s) through an in-vehicle speaker system prior to and/or after playing the music.

### SUMMARY

A method for providing meta data for a work includes designating a file for uploading data associated therewith to a telematics unit operatively connected to a vehicle and using meta data associated with the designed file, obtaining phonetic meta data for the designed file from an on-line service. The method further includes creating a phonetic meta data file associated with the designed file and including the obtained phonetic meta data, and transferring the phonetic metal data file to the telematics unit. Also disclosed herein is a system for providing the same.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for providing meta data for a work;

FIG. 2 is a flow diagram depicting an example of the method for providing meta data for a work; and

FIG. 3 is a flow diagram depicting an example of a method for generating phonetic meta data and an audio output within a vehicle.

### DETAILED DESCRIPTION

Examples of the method and system disclosed herein advantageously enable a user of a mobile vehicle to obtain meta data and phonetic meta data for a work or media file from a source outside the vehicle, and then upload such data to the vehicle. The meta data and phonetic meta data associated with the work or media file may be transferred from a portable electronic device to a telematics unit on-board the vehicle and saved in an electronic memory associated with the telematics unit. The meta data and the phonetic meta data uploaded to the telematics unit may be played, by the user in the vehicle, directly from the stored filed in the telematics unit, without having to upload the entire media file. This advantageously reduces the amount of memory needed for storing such files in an embedded vehicle module, at least in part because an all-inclusive music and meta database may be excluded from the memory because the user creates his/her own library. Further, the files stored at the telematics unit may be updated and/or changed as frequently as desired, for example, in the event that the phonetic meta data is inaccurate, the user desires a different selection of music, and/or the like.

It is to be understood that, as used herein, the term “user” includes vehicle owners, operators, and/or passengers. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

It is to be further understood that “communication” is to be construed to include all forms of communication, including direct and indirect communication. As such, indirect communication may include communication between two components with additional component(s) located therebetween.

Additionally, it is to be understood that the term “work,” as used herein, refers to various forms of media, non-limiting examples of which include music (e.g., a song), a literary piece, a documentary, and/or the like. It is further to be understood that, as used herein, the term “media” or “media file” may be used interchangeably with the term “work.”

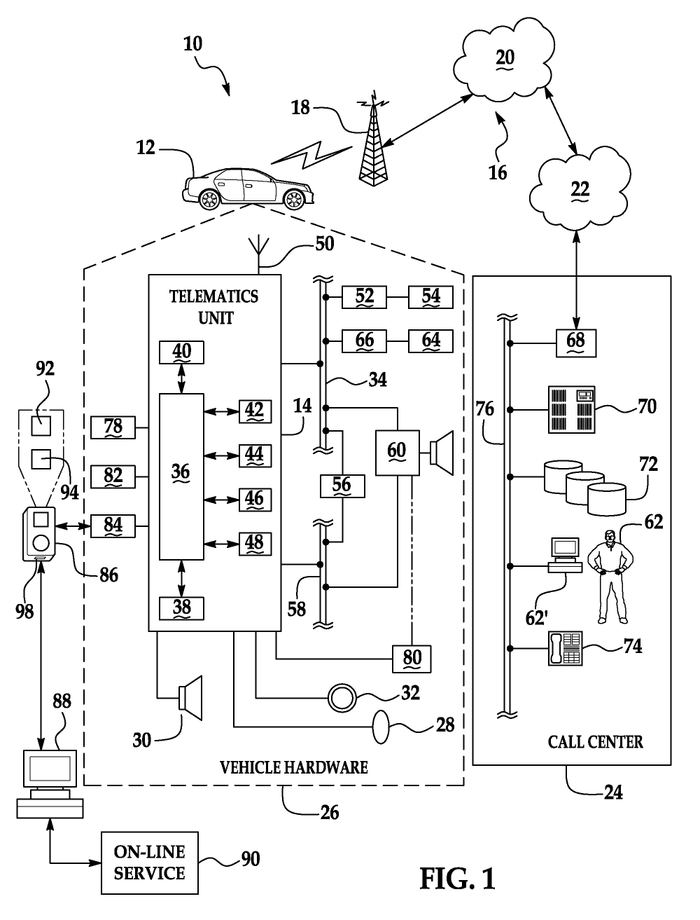

Referring now to FIG. 1, the system 10 includes a vehicle 12, a telematics unit 14, a wireless carrier/communication system 16 (including, but not limited to, one or more cell towers 18 and/or one or more base stations and/or mobile switching centers (MSCs) 20, which are generally owned and/or operated by one or more cellular service providers (not shown)), one or more land networks 22, and one or more call centers 24. In an example, the wireless carrier/communication system 16 is a two-way radio frequency communication system.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicle 12 is a mobile vehicle such as a motorcycle, car, truck, recreational vehicle (RV), boat, plane, etc., and is equipped with suitable hardware and software that enables it to communicate (e.g., transmit and/or receive voice and data communications) over the wireless carrier/communication system 16. It is to be understood that the vehicle 12 may also include additional components suitable for use in the telematics unit 14.

Some of the vehicle hardware 26 is shown generally in FIG. 1, including the telematics unit 14 and other components that are operatively connected to the telematics unit 14. Examples of such other hardware 26 components include a microphone 28, a speaker 30, and buttons, knobs, switches, keyboards, and/or controls 32. Generally, these hardware 26 components enable a user to communicate with the telematics unit 14 and any other system 10 components in communication with the telematics unit 14.

The telematics unit 14 further includes a universal serial bus (USB) plug-in or port 84 operatively connected thereto. The USB plug-in 84 is an interface generally used to connect a portable electronic device 86 to the telematics unit 14 for data exchange between the two or for one-way data upload from the portable electronic device 86 to the telematics unit 14. Non-limiting examples of portable electronic devices 86 include a portable digital music player (such as, e.g., an MP3 player or an iPod®), or other device capable of playing and/or storing thereon a work, a meta data file associated with the work, and/or a phonetic metal data file associated with the meta data of the work (as will be described in further detail below). In an example, the portable electronic device 86 also includes a USB port 98 operatively connected thereto. In an example, connection between the portable device 86 and the vehicle 12 is accomplished through the USB port 98 of the portable device 86 and the USB port 84 of the telematics unit 14. In some instances, the portable electronic device 86 may be configured with software and hardware for short-range wireless communications. In such instances, the telematics unit 14 may also be configured with a short-range wireless communication network 48 (e.g., a Bluetooth® unit) so that the device 86 and unit 14 are able to communicate wirelessly.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, the previously mentioned short-range wireless communication network 48 (e.g., a Bluetooth® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the real-time clock (RTC) 46. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies such as TDMA (time division multiple access), CDMA (code division multiple access) and GSM (global system for mobile telecommunications). In some instances, the protocol may be a short-range wireless communication technologies, such as Bluetooth®, dedicated short-range communications (DSRC), or Wi-Fi.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications preferably use radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the vehicle occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58.

Other hardware components that are operatively connected to the telematics unit 14 include an automatic speed recognition unit 78 and a text-to-speech engine 82. The automatic speech recognition (ASR) unit 78 receives human speech input and translates the input into digital, machine-readable signals. In an example, the ASR unit 78 also obtains and recognizes phonetic data input and translates the phonetic data input into digital signals. Using one or more data translation algorithms, the text-to-speech (TTS) engine 82 translates or otherwise converts the digital signals of the phonetic data into a human-understandable form. As will be described in further detail below, the phonetic data, in the human-understandable form, may ultimately be visually displayed to the user on a display 80 (which will also be described in further detail below) and/or audibly output to the user via the speaker 30.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, and/or the like. Non-limiting example sensor interface modules 66 include powertrain control, climate control, body control, and/or the like.

In a non-limiting example, the vehicle hardware 26 includes a display 80, which may be operatively connected to the telematics unit 14 directly, or may be part of the audio component 60. Non-limiting examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 16 may be a cellular telephone system or any other suitable wireless system that transmits signals between the vehicle hardware 26 and land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions. For example, the call center 24 may be configured to download to the telematics unit 14 a speech recognition grammar for updating phonetic meta data (which will be described in further detail below). According to the example shown here, the call center 24 generally includes one or more switches 68, servers 70, databases 72, live and/or automated advisors 62, 62′, as well as a variety of other telecommunication and computer equipment 74 that is known to those skilled in the art. These various call center components are coupled to one another via a network connection or bus 76, such as the one (vehicle bus 34) previously described in connection with the vehicle hardware 26.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or an automated response system 62′, and data transmissions are passed on to a modem or other piece of equipment (not shown) for demodulation and further signal processing. The modem preferably includes an encoder, as previously explained, and can be connected to various devices such as the server 70 and database 72. For example, database 72 may be designed to store subscriber profile records, subscriber behavioral patterns, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

It is to be understood that, although a cellular service provider (not shown) may be located at the call center 24, the call center 24 is a separate and distinct entity from the cellular service provider. In an example, the cellular service provider is located remote from the call center 24. A cellular service provider generally provides the user with telephone and/or Internet services. The cellular service provider is generally a wireless carrier (such as, for example, Verizon Wireless®, AT&T®, Sprint®, etc.). It is to be understood that the cellular service provider may interact with the call center 24 to provide service(s) to the user.

Still with reference to FIG. 1, the portable electronic device 86 may have associated therewith an electronic memory 92 configured to store a plurality of data files. As will be described in further detail below, such files are originally retrieved, by the user, from an on-line service 90 and downloaded to a user workstation 88. The data files may thereafter be downloaded to the portable device 86 by syncing the device 86 with the workstation 88.

The data files stored in the memory 92 of the portable device 86 are generally organized into folders, where each folder includes those files that are specific to a particular work. In an example, each data folder includes at least 1) a work or media file, and 2) a meta data file associated with the work or media file. Non-limiting examples of the meta data present in the meta data file include a title of the work, the name of the artist and/or composer of the work, a title of the album containing the work, the album track title and number, the genre of the work, the album cover art, the album credits, and/or compilation information. In another example, each folder also includes a phonetic meta data file associated with the meta data file of the work. In a non-limiting example, the phonetic meta data is the phonetic version of the meta data previously described. As a non-limiting example, the song “Flow” may include the artist meta data “Sade”, and the phonetic artist meta data “Shah-day”.

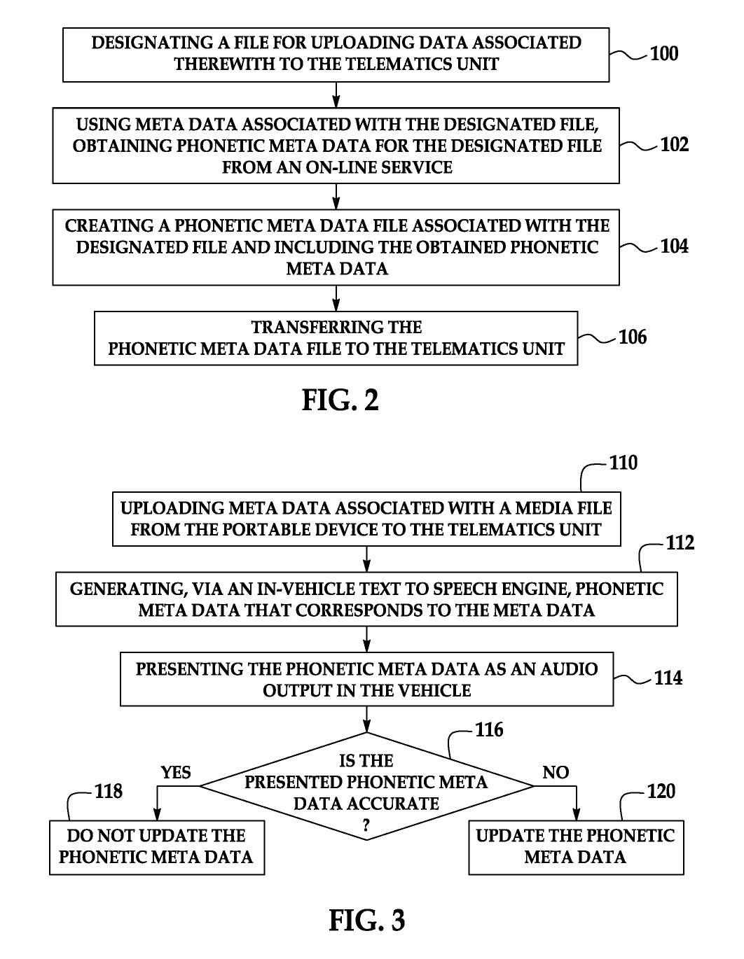

An example of the method for providing meta data for a work is shown in FIG. 2. The method begins by designating a file for uploading data associated therewith to the telematics unit 14 (as shown at reference numeral 100). For example, a particular work or media file is designated by the user at the user workstation 88 by 1) selecting the file from a bank of files already downloaded and saved in a user profile at the workstation 88, or 2) downloading a new file to the workstation 88 from the on-line service 90. It is to be understood that each of the files included in the user profile and/or a newly downloaded file includes meta data and phonetic meta data associated with the work.

Using the meta data associated with the designated work or media file, phonetic meta data associated with the meta data is obtained from the on-line service 90 (as shown by reference numeral 102). This may be accomplished by uploading the meta data to the on-line service 90 and requesting the phonetic meta data that corresponds with the uploaded meta data. The phonetic meta data for the designated file may then be downloaded to the user workstation 88 and saved, e.g., in an appropriate data folder.

At the user workstation 88, the work or media file, the meta data, and the phonetic meta data, organized into appropriate data folders, are then transferred, synced, or otherwise downloaded to the portable electronic device 86 and saved in the electronic memory 92 associated with the device 86. For example, the user may connect the portable device 86 to the user workstation 88 via, e.g., a USB connection. When the portable device 86 is connected, the workstation 88 automatically recognizes the portable device 86 and asks the user whether he/she wants to sync the portable device 86 with the workstation 88. In response thereto, the user may select some or all of the data folders saved in the user profile at the workstation 88 and those folders may then be transferred to the portable device 86.

The meta data and phonetic meta data associated with the work file may then be transferred from the portable device 86 to the telematics unit 14 (as shown by reference numeral 106). This may be accomplished by operatively connecting the portable device 86 to the vehicle 12 via, e.g., a USB connection. When the connection is made, the telematics unit 14 automatically recognizes the portable device 86 and asks the user whether he/she wants to sync the telematics unit 14 with the portable device 86. If the user indicates that he/she wants to sync the portable device 86 with the telematics unit 14, the meta data and phonetic meta data associated with the work file(s) are then transferred to the telematics unit 14. The uploaded files may be saved as meta data files and phonetic meta data files in the electronic memory 38 associated with the telematics unit 14. In some instances, the work file (e.g., an MP3 file) itself is not uploaded to the telematics unit 14. This enables the memory 38 to be smaller than, for example, if an entire work file library were to be saved on the memory 38. It is to be understood, however, that the work file may be uploaded if the user selects such file for upload.

Once the telematics unit 14 has been synced with the portable device 86, the user may disconnect the portable device 86. It is to be understood that the files uploaded remain in the memory 38 after the portable device 86 is disconnected. As such, the files saved in the memory 38 associated with the telematics unit 14 may be played in the vehicle 12 at any time. Media (e.g., music, literary works, talk shows, etc.) is output through the in-vehicle speaker system 30, and the telematics unit 14 is configured to recognize the media, for example, via information pulled from a broadcast stream, a compact disc, etc. The telematics unit 14 then retrieves the meta data and phonetic meta data associated with the output media. Prior to playing the music, while playing the music, and/or after the music has been played, the meta data and phonetic meta data associated with the media may be displayed on the display 80 and/or audibly output to the user via the in-vehicle speaker system 30. In an example, the phonetic meta data is presented as an audio output through the in-vehicle speaker system 30. In another example, the phonetic meta data is presented to the user on the display 80. It may be particularly desirable to present the phonetic meta data visually when such data is different from the meta data. For example, when the phonetic spelling of a song title is different from the meta data of the song title, it may be desirable to present both the meta data and the phonetic meta data.

When the phonetic meta data is presented to the user, the telematics unit 14 may ask the user whether the presented phonetic meta data is accurate. In an example, the inquiry may be relayed to the user as a pre-recorded audible message. In another example, the inquiry may be presented to the user on the display 80. In either case, the user may respond to the inquiry by providing an audible response using the in-vehicle microphone 28, actuating a function key or button indicating a “yes” or “no”, and/or the like.

In another example, if the user determines that the phonetic meta data is inaccurate, the telematics unit 14 establishes a communication with the call center 24 and requests from the call center 24 a speech recognition grammar that corresponds with an accurate pronunciation of the phonetic meta data. In response, the call center 24 downloads the grammar to the telematics unit 14. The grammar is then used to update the phonetic meta data file saved in the electronic memory 38.

In the event that the user finds that the presented phonetic meta data is accurate, the phonetic meta data file is not updated. In an example, once the user informs the telematics unit 14 that the phonetic meta data is accurate, future inquiries regarding the accuracy thereof are no longer presented to the user. If the user has indicated that the presented phonetic meta data is accurate and later determines that the phonetic meta data is, in fact, inaccurate, the user may contact the call center 24 and request that the phonetic meta data file saved in the electronic memory 38 of the telematics unit 14 be updated.

Also disclosed herein is a method for generating audio output within the vehicle 12, which is depicted in FIG. 3. The method begins by uploading meta data associated with a work file from the portable device 86 to the telematics unit 14 (as shown by reference numeral 110). This may be accomplished by connecting the portable device 86 to the vehicle 12 and transferring the meta data file from the portable device 86 to the telematics unit 14 (as similarly disclosed above for the method described in conjunction with FIG. 2). In the example shown in FIG. 3, it is to be understood that the work or media file may also be uploaded to the telematics unit 14, if desirable.

The uploaded meta data is used to generate, via the TTS engine 82, phonetic meta data that corresponds with the meta data (as shown by reference numeral 112). The generated phonetic meta data is then stored in the electronic memory 38 of the telematics unit 14. In an example, the TTS engine 82 generates the phonetic meta data by accessing an in-vehicle grapheme-to-phoneme dictionary and converting the meta data into the phonetic meta data. In another example, the TTS engine 82 generates the phonetic meta data by accessing and using grammars stored in the memory 38 of the telematics unit 14.

Once the phonetic meta data has been generated, the generated phonetic meta data is presented as an audio output in the vehicle 12, e.g., through the in-vehicle speaker system 30 (as shown by reference numeral 114). The generated phonetic meta data may be played after it is generated in order to verify its accuracy, or it may be played before/during/after the work associated with the phonetic meta data is played in the vehicle 12. The telematics unit 14 then asks the user whether the phonetic meta data is accurate (as shown by reference numeral 116). This inquiry may be audibly relayed to the user through, e.g., the speaker system 30, or may be visually relayed to the user by, e.g., displaying the inquiry on the in-vehicle display 80.

As similarly disclosed above in connection with FIG. 2, in the event that the user finds that the presented phonetic meta data is accurate, the phonetic meta data file is not updated (as shown by reference numeral 118).

However, in the event that the user determines that the presented phonetic meta data is inaccurate, the phonetic meta data file saved in the memory 38 may be updated (as shown by reference numeral 120). For example, to update the phonetic meta data file, the telematics unit 14 establishes a communication with the call center 24 and requests a speech recognition grammar that corresponds with an accurate pronunciation of the phonetic meta data. The call center 24 downloads the grammar to the telematics unit 14, which is used to update the phonetic meta data file saved in the electronic memory 38.

While several examples have been described in detail, it will be apparent to those skilled in the art that the disclosed examples may be modified. Therefore, the foregoing description is to be considered exemplary rather than limiting.

1. A method for providing meta data for a work, comprising:
designating a file for uploading data associated therewith to a telematics unit operatively connected to a vehicle;
using meta data associated with the designated file, obtaining phonetic meta data for the designated file from an on-line service;
creating a phonetic meta data file associated with the designated file and including the obtained phonetic meta data; and
transferring the phonetic meta data file to the telematics unit.

2. The method as defined in claim 1 wherein the phonetic meta data is recognizable by an automatic speech recognition unit and a text to speech engine operatively connected to the telematics unit.

3. The method as defined in claim 1, further comprising:
presenting the phonetic meta data as an audio output in the vehicle; and
inquiring as to whether the presented phonetic meta data is accurate.

4. The method as defined in claim 3 wherein if the phonetic meta data is inaccurate, the method further comprises:
establishing communication between the telematics unit and a call center;
requesting a speech recognition grammar that corresponds with an accurate pronunciation of the phonetic meta data;
downloading, from the call center to the telematics unit, the grammar that corresponds with the accurate pronunciation of the phonetic meta data; and
updating the phonetic meta data with the downloaded speech recognition grammar.

5. The method as defined in claim 1 wherein obtaining the phonetic meta data is accomplished by:
uploading the meta data associated with the designated file to the on-line service; and
requesting phonetic meta data that corresponds with the uploaded meta data.

6. The method as defined in claim 1 wherein creating the phonetic meta data file includes downloading the obtained phonetic meta data to a portable electronic device.

7. The method as defined in claim 6 wherein transferring the phonetic meta data file to the telematics unit is accomplished by operatively connecting the portable electronic device to the vehicle.

8. A system for providing meta data for a work, comprising:
an on-line service;
a portable electronic device, including:
a designated file for uploading data associated therewith, the designated file including meta data; and
a phonetic meta data file associated with the designated file and containing phonetic meta data obtained from the on-line service;
a telematics unit operatively connected within a vehicle and configured to receive the phonetic meta data file from the portable electronic device; and
means for establishing data exchange communication or data upload communication between the portable electronic device and the telematics unit.

9. The system as defined in claim 8, further comprising an automatic speech recognition unit and a text to speech engine operatively connected to the telematics unit.

10. The system as defined in claim 8, further comprising a call center in selective operative communication with the telematics unit, wherein the call center is configured to download to the telematics unit, in response to a request, a speech recognition grammar for updating the phonetic meta data.

11. The system as defined in claim 8 wherein the portable electronic device and the vehicle each includes a USB port, and wherein the means for establishing data exchange communication or data upload communication is a USB connector.

12. The system as defined in claim 8 wherein the designated file is a music file and wherein the meta data includes song title, artist, and album title.

13. A method for generating audio output within a vehicle, comprising:
uploading meta data associated with a media file from a portable device to a telematics unit within the vehicle;
generating, via an in-vehicle text to speech engine, phonetic meta data that corresponds to the uploaded meta data;
presenting the phonetic meta data as an audio output in the vehicle; and
inquiring as to whether the presented phonetic meta data is accurate.

14. The method as defined in claim 13 wherein if the phonetic meta data is inaccurate, the method further comprises:
establishing communication between the telematics unit and a call center;
requesting a speech recognition grammar that corresponds with an accurate pronunciation of the meta data;
downloading, from the call center to the telematics unit, the grammar that corresponds with the accurate pronunciation of the meta data; and
updating the phonetic meta data with the downloaded speech recognition grammar.

15. The method as defined in claim 13 wherein the phonetic meta data is stored in an in-vehicle memory resident in the telematics unit.

16. The method as defined in claim 13 wherein the in-vehicle text to speech engine accesses an in-vehicle grapheme to phoneme dictionary to convert the meta data to phonetic data.

17. The method as defined in claim 13 wherein the phonetic meta data is generated using grammars stored in an in-vehicle memory.

18. The method as defined in claim 13 wherein the phonetic meta data is presented prior to an audio presentation of music associated with the media file.
